(19) United States
(12) Patent Application Publication
(10) Pub. No.: US 2026/0210459 A1
(43) Pub. Date: Jul. 23, 2026

(54) LIQUID DISTRIBUTOR BRANCH PIPE STRUCTURE AND LIQUID DISTRIBUTOR

(71) Applicant: Hanshan Ruike Metal Co., Ltd., Ma’anshan, (CN)

(72) Inventors: Zhuangwei SI, Ma’anshan, (CN); Pan GAO, Ma’anshan, (CN)

(21) Appl. No.: 19/290,372

(22) Filed: Aug. 5, 2025

(30) Foreign Application Priority Data
Jan. 23, 2025 (CN) 2025201728039

(51) Int. Cl. F16L 13/02; F16L 13/007; F16L 41/08

(52) U.S. Cl. CPC F16L 13/0254; F16L 13/007; F16L 41/082

(57) ABSTRACT

The present invention provides a liquid distributor branch pipe structure and a liquid distributor. The liquid distributor branch pipe structure includes two branch pipe components. Each branch pipe component includes a stainless steel pipe and a copper connecting pipe welded to an end of the stainless steel pipe, and a stainless steel pipe on one of the branch pipe components is welded to a liquid distributor body; each copper connecting pipe includes a first assembly section welded to a corresponding stainless steel pipe and a second assembly section sleeved with only the other copper connecting pipe, a sleeving gap is formed between the two copper connecting pipes, and a brazed layer formed by non-furnace brazing is formed within the sleeving gap.

### CROSS-REFERENCE TO RELATED APPLICATIONS

This Non-provisional application is based upon and claims priorities under 35 U.S.C. § 119(a) on to Chinese Patent Application No. 2025201728039 filed on Jan. 23, 2025, the entire contents of which are hereby incorporated by reference.

### BACKGROUND OF THE INVENTION

### Field of the Invention

The present invention relates to the field of refrigeration accessories, and in particular to a liquid distributor branch pipe structure and a liquid distributor.

### Description of the Related Art

A multi-channel small-diameter heat exchanger has advantages of a strong heat transfer capability, a low material utilization amount, a low refrigerant injection amount, low pressure drop, and the like. To evenly distribute a throttled refrigerant in gas-liquid two-phase state to each channel of the heat exchanger, a liquid distributor needs to be introduced before the heat exchanger. Traditional liquid distributors are primarily made of copper. However, with the continuous increase in copper price, the liquid distributors gradually develop toward low costs with reduced copper replaced by steel.

In traditional copper liquid distributors, flame brazing is usually used to weld each copper connecting pipe. Although welding blockage easily occurs when copper connecting pipes with small diameters are welded, the flame brazing is still a main welding method for the traditional copper liquid distributors due to advantages of simple operation, flexible welding, high efficiency, and the like. Stainless steel is an alloy material based on iron and containing various elements such as chromium, nickel, titanium, manganese, and the like. A surface oxide of the stainless steel has a high melting point during flame welding in the air, and cannot be reduced even with the addition of a brazing flux. Due to the influence of the surface oxide, a bonding strength between a brazed layer formed after brazing and a base material is poor, which leads to a difficulty in meeting connection strength and airtightness requirements of a refrigeration system after branch pipes are welded. To be specific, it is difficult to use flame brazing to connect the liquid distributor branch pipes after stainless steel treatment. Therefore, tunnel furnace brazing with a protective atmosphere is mainly used for a current liquid distributor after stainless steel treatment. However, to meet layout requirements for customer refrigeration system pipelines, stainless steel branch pipes are usually long. When the stainless steel branch pipes are assembled with a cylindrical liquid distributor body, an assembly component with large axial and radial sizes and complex structure is formed. During the tunnel furnace brazing, the large-sized assembly component occupies an extremely large piece of space inside a tunnel furnace, seriously affecting welding efficiency, resulting in high production costs, and not conducive to flexible arrangement of a small batch of liquid distributor orders with a plurality of categories and specifications.

### BRIEF SUMMARY OF THE INVENTION

The present invention provides a liquid distributor branch pipe structure and a liquid distributor for implementing efficient welding, to overcome deficiencies in the prior art.

To achieve the above purpose, the present invention provides a liquid distributor branch pipe structure, including two branch pipe components, each branch pipe component includes a stainless steel pipe and a copper connecting pipe welded to an end of the stainless steel pipe, and a stainless steel pipe on one of the branch pipe components is welded to a liquid distributor body;

each copper connecting pipe includes a first assembly section welded to a corresponding stainless steel pipe and a second assembly section sleeved with only the other copper connecting pipe, a sleeving gap is formed between the two copper connecting pipes, and a brazed layer formed by non-furnace brazing is formed within the sleeving gap; and a shortest axial spacing from an end of a second assembly section of a sleeving copper connecting pipe to an exposed region of each stainless steel pipe is greater than or equal to Φ, where Φ is an outer diameter of an inserted copper connecting pipe.

According to an embodiment of the present invention, at least one of the two copper connecting pipes further includes a soft connection section located between the two assembly sections, and the soft connection section is a region, on the copper connecting pipe, that is not assembled with another pipe fitting.

According to an embodiment of the present invention, at least one bent part is formed on the soft connection section.

According to an embodiment of the present invention, a copper connecting pipe in each branch pipe component is sleeved on an end of a corresponding stainless steel pipe.

According to an embodiment of the present invention, in an extension direction of the brazed layer, a solder accommodating chamber is formed, between the two branch pipe components, at an end of the sleeving gap and for accommodating a brazing solder.

According to an embodiment of the present invention, the sleeving gap includes an effective depth region of the brazed layer and an excess solder storage region distributed along an extension direction of the brazed layer; and an effective depth of the brazed layer is L1≥0.4 Φ, where Φ is an outer diameter of the inserted copper connecting pipe of the two copper connecting pipes.

According to an embodiment of the present invention, an outer diameter of a stainless steel pipe in at least one branch pipe component is set to be greater than or equal to 2 mm and less than or equal to 4.5 mm, with a wall thickness greater than or equal to 0.18 mm and less than or equal to 0.52 mm.

According to an embodiment of the present invention, a branch pipe component, away from the liquid distributor body, of the two branch pipe components, further includes a copper connection section welded to the other end of the stainless steel pipe opposite to the copper connecting pipe and configured to connect an external pipeline.

In another aspect, the present invention further provides a liquid distributor branch pipe structure, including two branch pipe components, each branch pipe component includes a stainless steel pipe and a copper connecting pipe welded to an end of the stainless steel pipe, and a stainless steel pipe on one of the branch pipe components is welded to a liquid distributor body;

copper connecting pipes on the two branch pipe components are sleeved, and a brazed layer formed by non-furnace brazing is formed in a sleeving gap, a stainless steel pipe in one branch pipe component extends out of a corresponding copper connecting pipe to form a stainless steel extension section, the stainless steel extension section extends into the other branch pipe component, a blocking region is formed at an assembly gap or a spacing chamber between an outer peripheral wall of the stainless steel extension section and an inner peripheral wall of the other branch pipe component, to block extension of the brazed layer towards an end surface of the stainless steel extension section.

According to an embodiment of the present invention, the stainless steel extension section extends into a stainless steel pipe in the other branch pipe component, an end surface of a copper connecting pipe corresponding to the stainless steel extension section abuts against an end surface of a stainless steel pipe in the other branch pipe component, and the blocking region is an assembly gap between the outer peripheral wall of the stainless steel extension section and an inner peripheral wall of the stainless steel pipe in the other branch pipe component.

According to an embodiment of the present invention, the stainless steel extension section extends into a stainless steel pipe of the other branch pipe component, an end surface of a copper connecting pipe corresponding to the stainless steel extension section does not abut against an end surface of a stainless steel pipe in the other branch pipe component, and the blocking region includes a spacing chamber between the outer peripheral wall of the stainless steel extension section and an inner peripheral wall of a copper connecting pipe in the other branch pipe component and an assembly gap between the outer peripheral wall of the stainless steel extension section and an inner peripheral wall of the stainless steel pipe in the other branch pipe component.

According to an embodiment of the present invention, the stainless steel extension section extends into a copper connecting pipe in the other branch pipe component, and the blocking region is a spacing chamber between the outer peripheral wall of the stainless steel extension section and an inner peripheral wall of the copper connecting pipe in the other branch pipe component.

According to an embodiment of the present invention, each copper connecting pipe includes a first assembly section and a second assembly section, and second assembly sections of the two copper connecting pipes are sleeved; and a shortest axial spacing from an end of a second assembly section of a sleeving copper connecting pipe to an exposed region of each stainless steel pipe is greater than or equal to Φ, where Φ is an outer diameter of an inserted copper connecting pipe.

According to an embodiment of the present invention, a copper connecting pipe in each branch pipe component is sleeved on an end of a corresponding stainless steel pipe.

According to an embodiment of the present invention, an outer diameter of a stainless steel pipe in at least one branch pipe component is set to be greater than or equal to 2 mm and less than or equal to 4.5 mm, with a wall thickness greater than or equal to 0.18 mm and less than or equal to 0.52 mm.

According to an embodiment of the present invention, a branch pipe component, away from the liquid distributor body, of the two branch pipe components, further includes a copper connection section welded to the other end of the stainless steel pipe opposite to the copper connecting pipe and configured to connect an external pipeline.

In another aspect, the present invention further provides a liquid distributor, including a plurality of the above liquid distributor branch pipe structures.

In summary, the liquid distributor branch pipe structure provided in the present invention includes two branch pipe components, and each of the two branch pipe components includes the stainless steel pipe and the copper connecting pipe. The copper connecting pipes inside the two branch pipe components are sleeved to form welding of a same type of metal based on a copper material. Compared with a stainless steel material, the oxide film on the surface of the copper material can be reduced and removed by adding the brazing flux. The brazing solder can also wet the surface of the copper base material well in the air and spread out, forming the dense, stable, and high-strength brazed layer. This provides conditions for simple, efficient, and flexible non-furnace brazing of a long branch pipe component after stainless steel treatment. In addition, during welding, the shortest axial distance from the end of the second assembly section of the sleeving copper connecting pipe to the exposed region of each stainless steel pipe is controlled to effectively reduce the thermal impact of welding heat on a crystal structure of the stainless steel pipe during non-furnace brazing, ensuring an excellent connection strength and pressure resistance of the stainless steel pipe after welding. Further, each copper connecting pipe is disposed to include the first assembly section welded to a corresponding stainless steel pipe and the second assembly section only sleeved with the other copper connecting pipe. Through this setting, only the second assembly sections of the two copper connecting pipes need to be heated by the welding heat during non-furnace brazing, which not only has a short heating time and high welding efficiency, but also greatly reduces input welding heat, thereby further reducing the thermal impact of the welding heat on the stainless steel pipes during non-furnace brazing.

In addition, the solder accommodating chamber can be disposed at the end of the sleeving gap between the two copper connecting pipes, the excess solder storage region can be disposed in the sleeving gap, the stainless steel extension section can be disposed on one stainless steel pipe to form the blocking region, or the like, to effectively prevent welding blockage caused by an excess solder or flow welding when two copper connecting pipes are brazed through non-furnace brazing.

To make the above and other objectives, features, and advantages of the present invention more obvious and understandable, the following preferred embodiments are presented in detail with reference to accompanying drawings.

### BRIEF DESCRIPTION OF THE DRAWINGS

FIG. 1 is a partial schematic diagram of a liquid distributor branch pipe structure according to a first embodiment of the present invention;

FIG. 2 is a schematic enlarged diagram of a point A in FIG. 1;

FIG. 3 to FIG. 8 are partial schematic diagrams of the liquid distributor branch pipe structure according to another embodiment of the present invention;

FIG. 9 is a schematic structural diagram of a liquid distributor according to the first embodiment of the present invention;

FIG. 10 to FIG. 22 are schematic structural diagrams of the liquid distributor according to another embodiment of the present invention;

FIG. 23 is a partial schematic diagram of the liquid distributor branch pipe structure according to a second embodiment of the present invention;

FIG. 24 is a schematic enlarged diagram of a point B in FIG. 23;

FIG. 25 is a schematic structural diagram of a brazing solder in FIG. 24 penetrating into an excess solder storage region;

FIG. 26 is a partial schematic diagram of the liquid distributor branch pipe structure according to a third embodiment of the present invention;

FIG. 27 is a schematic enlarged diagram of a point C in FIG. 26;

FIG. 28 is a schematic diagram of flowing of a brazing solder in a liquid distributor branch pipe structure shown in FIG. 27 for brazing;

FIG. 29 is a partial schematic diagram of a liquid distributor branch pipe structure according to another embodiment of the present invention;

FIG. 30 is a partial schematic diagram of the liquid distributor branch pipe structure before brazing according to a fourth embodiment of the present invention;

FIG. 31 is a schematic structural diagram of the liquid distributor branch pipe structure shown in FIG. 30 after brazing;

FIG. 32 is another schematic structural diagram of the liquid distributor branch pipe structure shown in FIG. 30 after brazing;

FIG. 33 is a partial schematic diagram of the liquid distributor branch pipe structure before brazing according to a fifth embodiment of the present invention;

FIG. 34 is a schematic enlarged diagram of a point D in FIG. 33;

FIG. 35 is a schematic diagram of flowing of a brazing solder in a liquid distributor branch pipe structure shown in FIG. 33 for brazing;

FIG. 36 is a partial schematic diagram of a liquid distributor branch pipe structure according to another embodiment of the present invention; and

FIG. 37 to FIG. 40 are partial schematic diagrams of the liquid distributor branch pipe structure with a different blocking region according to another embodiment of the present invention.

### DETAILED DESCRIPTION OF THE INVENTION

### First Embodiment

Due to a dense oxidation layer on a surface of a stainless steel material, it is difficult to use a high-efficient welding method (such as flame brazing) in the air on a liquid distributor branch pipe after stainless steel treatment, and only tunnel furnace brazing with a protective atmosphere can be used. Further, the liquid distributor branch pipe is not only long in an axial length, but also has a large radial size after being assembled with a liquid distributor body. This results in an extremely low quantity of products that can be welded in a single furnace pass during tunnel furnace brazing, severely affecting production efficiency and costs. In addition, this welding method is not conducive to small batch customization of products with various types and various specifications such as the liquid distributor.

In view of this, this embodiment provides a liquid distributor branch pipe structure that allows for efficient brazing in the air after stainless steel treatment. The liquid distributor branch pipe structure includes two branch pipe components. Each branch pipe component includes a stainless steel pipe and a copper connecting pipe welded to an end of the stainless steel pipe, and a stainless steel pipe on one of the branch pipe components is welded to a liquid distributor body. Each copper connecting pipe includes a first assembly section welded to a corresponding stainless steel pipe and a second assembly section sleeved with only the other copper connecting pipe. A sleeving gap is formed between the two copper connecting pipes, and a brazed layer formed by non-furnace brazing is formed within the sleeving gap. A shortest axial spacing from an end of a second assembly section of a sleeving copper connecting pipe to an exposed region of each stainless steel pipe is greater than or equal to Φ, where Φ is an outer diameter of an inserted copper connecting pipe.

For ease of description, the two branch pipe components are named as a first branch pipe component 1 and a second branch pipe component 2 in this embodiment. Correspondingly, a stainless steel pipe inside the first branch pipe component 1 is indicated by a reference number 11, and a copper connecting pipe inside is indicated by a reference number 12; and a stainless steel pipe inside the second branch pipe component 2 is indicated by a reference number 21, and a copper connecting pipe inside is indicated by a reference number 22.

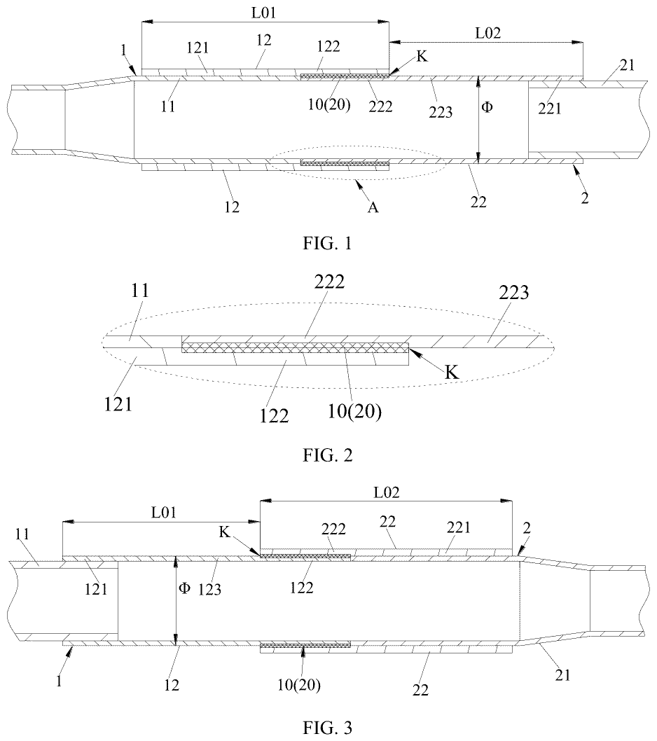

As shown in FIG. 1, a first assembly section 121 of the copper connecting pipe 12 in the first branch pipe component 1 is sleeved on an end of the corresponding stainless steel pipe 11; and a first assembly section 221 of a copper connecting pipe 22 in the second branch pipe component 2 is also sleeved on an end of the corresponding stainless steel pipe 21. A second end assembly section 222 of the copper connecting pipe 22 in the second branch pipe component 2 is inserted into a second assembly section 122 of the copper connecting pipe 12 in the first branch pipe component 1, and a sleeving gap 20 is formed between two copper connecting pipes. A brazed layer 10 formed by non-furnace brazing is formed within the sleeving gap 20. In FIG. 1 and FIG. 2, because the sleeving gap is filled with the brazed layer 10, a position of the sleeving gap 20 is also a position of the brazed layer 10.

In the liquid distributor branch pipe structure provided in this embodiment, the copper connecting pipe 12 and the copper connecting pipe 22 inside the two branch pipe components are sleeved to form the same metal welding of a copper material. Compared with a stable oxide that is not easily removed by a brazing flux, such as Cr₂O₃ (chromium sesquioxide) and TiO₂ (titanium dioxide) formed on a stainless steel surface, an oxide such as copper oxide, cuprous oxide, or zinc oxide formed on a surface of a copper material is easily reduced by a reducing gas or removed by the brazing flux. Therefore, the liquid distributor branch pipe structure provided in this embodiment only requires the use of the reducing gas or the addition of the brazing flux to braze the two copper connecting pipes 12, 22 in the air, thereby implementing non-furnace brazing on the two branch pipe components 1, 2 after stainless steel treatment. The non-furnace brazing on the two branch pipe components 1 and 2 allows each branch pipe component to be separately processed or assembled with other components for processing. This not only simplifies a welding manner and is efficient, but also provides a very flexible processing manner.

In this embodiment, each branch pipe component includes a stainless steel pipe and a copper connecting pipe. Processing of the branch pipe component involves welding dissimilar metals. Therefore, tunnel furnace brazing is still used for processing each branch pipe component. Specifically, the first branch pipe component 1 can be assembled and welded together with the liquid distributor body, and the second branch pipe component 2 can be welded separately. Although a length of a body assembly component is increased after the first branch pipe component 1 is assembled with the liquid distributor body, compared with an integral branch pipe structure, a length of the first branch pipe component 1 is extremely short, which has a limited influence on welding efficiency of the liquid distributor body, or even does not affect the welding efficiency of the liquid distributor body. Preferably, the length of the first branch pipe component 1 can be controlled during design to ensure that an axial length of the body assembly component is less than a height of a tunnel furnace. In this case, the body assembly component can be vertically placed on a tunnel furnace conveyor belt, and a quantity of welding operations in a single furnace pass is exactly the same as a quantity of the liquid distributor body for separate welding. To be specific, adding the first branch pipe component 1 does not affect welding efficiency of the liquid distributor body.

Although a length of the second branch pipe component 2 is relatively long, a radial size of the second branch pipe component 2 is extremely small. To be specific, compared with a height of the tunnel furnace, diameters of the stainless steel pipe and the copper connecting pipe are extremely small. During tunnel furnace brazing, a plurality of second branch pipe components 2 can be stacked and placed on a conveyor belt of the tunnel furnace to increase a quantity of the second branch pipe components in a single furnace pass, greatly improving welding efficiency. Finally, the second assembly sections 122, 222 of the two copper connecting pipes are brazed in the air, and the brazed layer 10 is formed within the sleeving gap 20 between the two copper connecting pipes, to implement efficient welding of the liquid distributor branch pipe after stainless steel treatment.

In this embodiment, the length of the first branch pipe component 1 assembled and welded with the liquid distributor body is less than a length of the second branch pipe component 2. A length of a branch pipe component means a centerline length from one end to the other end of the branch pipe component. However, any limitation is not made thereto in the present invention. In other embodiments, lengths of two branch pipe components can also be set to be basically the same; or the length of the second branch pipe component may be slightly less than the length of the first branch pipe component. A stainless steel pipe in each branch pipe component can be either a straight pipe or a bent pipe.

To more intuitively represent the brazed layer 10 between the second assembly sections 122, 222 of the two copper connecting pipes in the stainless steel branch pipe structure, the present invention does not identify the brazed layer formed by furnace brazing between the stainless steel pipe and the copper connecting pipe in each branch pipe component. However, in an actual product, a brazed layer made of tin bronze or a brazed layer made of another brazing solder with a liquidus temperature below 920 degrees Celsius is formed between the stainless steel pipe and the copper connecting pipe in each branch pipe component.

In this embodiment, the brazed layer 10 between the two copper connecting pipes 12, 22 is formed by flame brazing. Specifically, a brazing position K (such as a welding gun position for flame brazing) is formed at an end of the second assembly section of the sleeving copper connecting pipe after the two copper connecting pipes are sleeved. In FIG. 1 and FIG. 2, the sleeving copper connecting pipe is the copper connecting pipe 12 inside the first branch pipe component, and the brazing position K is an end of the second assembly section 122 of the copper connecting pipe 12. In this embodiment, flame brazing is used as an example for description. However, any limitation is not made thereto in the present invention. In other embodiments, other non-furnace brazing manners such as induction brazing, arc brazing, laser brazing, or electron beam brazing can alternatively be used to form the brazed layer in the air.

In this embodiment, the stainless steel pipes 11 and 21 inside the two branch pipe components are both austenitic stainless steel with high chromium content, which has extremely high heat resistance and corrosion resistance. However, a brazing temperature has a significant impact on the austenitic stainless steel, and usually a brazing heating temperature for the austenitic stainless steel should not be extremely high. Specifically, when the brazing temperature exceeds 1150° C., a grain size of the austenitic stainless steel begins to grow rapidly, and once the grain size grows, heat treatment cannot be used to refine the grain size. In addition, for austenitic stainless steel with a high carbon content but without stable elements such as titanium or niobium, such as 12Cr18N9, 17Cr18N9, or the like, when the brazing temperature stays within a sensitization temperature range (500° C. -850° C.) , a chromium carbide precipitates along a grain boundary, causing chromium depletion and intergranular corrosion, resulting in a brittle stainless steel material. Further, the austenitic stainless steel has a relatively high coefficient of linear expansion, which is greatly affected by the brazing temperature and generates a significant thermal stress inside, severely affecting a strength of the austenitic stainless steel.

In this embodiment, a phosphorus copper brazing solder is used for flame brazing for the second assembly sections 122, 222 of the two copper connecting pipes. A flame brazing temperature is approximately 750° C., which is relatively high and within the sensitization temperature range of the stainless steel material. If flame directly radiates to surfaces of the stainless steel pipes on both sides during brazing, precipitation of chromium carbide occurs inside the stainless steel pipes, seriously affecting a connection strength and corrosiveness. In addition, short-term rapid heating also causes a thermal stress inside, further affecting the connection strength, which is particularly obvious when a wall thickness of the stainless steel pipe is thin.

To resolve this problem, shortest axial spacings L01, L02 from ends (namely, a welding position K) of second assembly sections of sleeving copper connecting pipes to exposed regions of all stainless steel pipes are greater than or equal to Φ, where Φ is an outer diameter of an inserted copper connecting pipe. Based on isolation of the corresponding copper connecting pipes within the shortest axial spacings L01 and L02, the brazing flame does not directly radiate to the surfaces of the stainless steel pipes on both sides, reducing the thermal impact on the stainless steel pipes and effectively resolving a problem of poor performance of the stainless steel pipes caused by direct radiation of flame heat during brazing.

In this embodiment, the exposed region means a region in which the stainless steel pipe is exposed at the first assembly section of the corresponding copper connecting pipe. Specifically, when a copper connecting pipe is sleeved on a corresponding stainless steel pipe, an exposed region of the stainless steel pipe means an outer peripheral wall of the stainless steel pipe at an end of a first assembly section of the copper connecting pipe. When the copper connecting pipe is inserted into the corresponding stainless steel pipe, the exposed region of the stainless steel pipe means an end of the stainless steel pipe at the first assembly section of the copper connecting pipe.

In this embodiment, the copper connecting pipe inside each branch pipe component is sleeved on the corresponding stainless steel pipe, and the copper connecting pipe 12 inside the first branch pipe component is a sleeving copper connecting pipe. As shown in FIG. 1, in the first branch pipe component 1, the exposed region of the stainless steel pipe 11 is an outer peripheral wall of the stainless steel pipe 11 at the end of the first assembly section 121 of the copper connecting pipe. Therefore, the axial spacing L01 is an axial spacing from an end (namely, welding position K) of the second assembly section 122 of the copper connecting pipe 12 to the end of the first assembly section 121. In the second branch pipe component 2, the exposed region of the stainless steel pipe 21 is an outer peripheral wall of the stainless steel pipe 21 at the end of the first assembly section 221 of the copper connecting pipe. Therefore, the axial distance L02 is an axial spacing from the end (namely, welding position K) of the second assembly section 122 of the copper connecting pipe 12 to the end of the first assembly section 221 of the copper connecting pipe 22.

The present invention does not limit a sleeving manner for the two copper connecting pipes. In other embodiments, the copper connecting pipe 22 inside the second branch pipe component 2 can alternatively be disposed to be sleeved on the copper connecting pipe 12 inside the first branch pipe component 1, as shown in FIG. 3. In this case, the copper connecting pipe 22 inside the second branch pipe component is a sleeving copper connecting pipe, and the end of the second assembly section 222 is a position K at which a welding gun of flame brazing is located. Correspondingly, the two axial spacings L01, L02 are also based on the position K at which the welding gun of flame brazing is located.

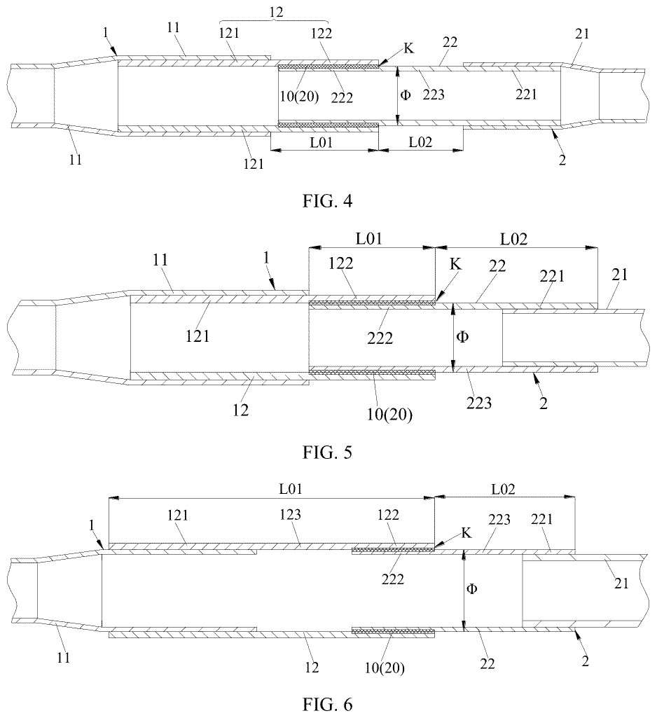

In this embodiment, for example, each copper connecting pipe in each branch pipe component is sleeved on a corresponding stainless steel pipe. However, any limitation is not made thereto in the present invention. In other embodiments, as shown in FIG. 4, two copper connecting pipes can alternatively be inserted into corresponding stainless steel pipes. In FIG. 4, the copper connecting pipe 12 inside the first branch pipe component is a sleeving copper connecting pipe. In the first branch pipe component 1, the first assembly section 121 of the copper connecting pipe 12 is inserted into a corresponding stainless steel pipe 11, and an exposed region of the stainless steel pipe 11 means an end of the stainless steel pipe 11 at the first assembly section 121 of the copper connecting pipe. An axial spacing L01 is an axial spacing from an end of the second assembly section 122 of the copper connecting pipe 12 to an end of the stainless steel pipe 11. In the second branch pipe component 2, the first assembly section 221 of the copper connecting pipe 22 is inserted into the stainless steel pipe 21, and an exposed region of the stainless steel pipe 21 means an end of the stainless steel pipe 21 at the first assembly section 221. The axial spacing L02 is an axial spacing from an end of the second assembly section 122 of the copper connecting pipe 12 to an end of the stainless steel pipe 21. Although the copper connecting pipe 12 inside the first branch pipe component in FIG. 4 is a sleeving copper connecting pipe, the present invention does not limit this in any way. In other embodiments, the copper connecting pipe inside the second branch pipe component can alternatively be used as the sleeving copper connecting pipe.

Alternatively, as shown in FIG. 5, a copper connecting pipe in one of the branch pipe components is sleeved on a corresponding stainless steel pipe, while a copper connecting pipe in the other branch pipe component can be inserted into a corresponding stainless steel pipe. In FIG. 5, the copper connecting pipe 12 inside the first branch pipe component is a sleeving copper connecting pipe. In the first branch pipe component 1, an exposed region of the stainless steel pipe 11 is an end of the stainless steel pipe 11 at the first assembly section 121 of the copper connecting pipe. In the second branch pipe component 2, an exposed region of the stainless steel pipe 21 is an outer peripheral wall of the stainless steel pipe 21 at the first assembly section 221 of the copper connecting pipe.

Further, as shown in FIG. 1, in the liquid distributor branch pipe structure provided in this embodiment, the second assembly section 122 of the copper connecting pipe 12 in the first branch pipe component is only sleeved with the second assembly section 222 of the copper connecting pipe 22. Similarly, the second assembly section 222 of the copper connecting pipe 22 is only sleeved with the second assembly section 122 of the copper connecting pipe 12. This setting ensures that during flame brazing, welding heat only needs to heat the second assembly sections 122, 222 of the two copper connecting pipes, which not only shortens the heating time but also increases the welding efficiency. In addition, short-term brazing can greatly reduce input welding heat, thereby further reducing the influence of welding heat radiation on the stainless steel pipes on both sides during flame brazing, and ensuring an excellent connection strength and forming and processing capabilities of the stainless steel pipes in the two branch pipe components after brazing.

In this embodiment, as shown in FIG. 1, the copper connecting pipe 22 inside the second branch pipe component 2 also includes a soft connection section 223 located between two assembly sections (the first assembly section 221 and the second assembly section 222). In this structure, the soft connection section 223 is not sleeved on other components and has low hardness and excellent forming and processing capabilities. When the liquid distributor branch pipe structure is connected to an external pipeline, at least one bent part can be processed on the soft connection section 223, to enable the end of the second branch pipe component 2 to face a system pipeline interface to be connected. However, any limitation is not made thereto in the present invention. In other embodiments, as shown in FIG. 3, the copper connecting pipe 12 inside the first branch pipe component 1 may also be disposed to include a first assembly section 121, a second assembly section 122, and a soft connection section 123 located in the middle. Similarly, in this structure, the soft connection section 123 is not sleeved on other components and has low hardness and excellent forming and processing capabilities. In other embodiments, the copper connecting pipes of the two branch pipe components may alternatively be provided with the soft connection sections, as shown in FIG. 6.

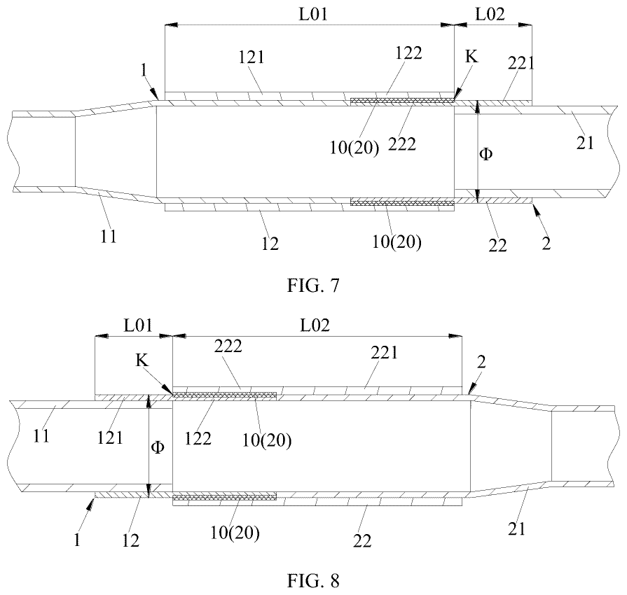

FIG. 7 is a liquid distributor branch pipe structure according to another embodiment of the present invention. This structure is basically the same as the liquid distributor branch pipe structure shown in FIG. 1, with a difference as follows: each of the two copper connecting pipes in this structure includes only the first assembly section and the second assembly section, without the soft connection section. In this case, the second assembly section 222 of the copper connecting pipe in the second branch pipe component 2 is inserted into the second assembly section 122 of the copper connecting pipe in the first branch pipe component 1, and an inserted end basically abuts against an end of the stainless steel pipe 11 in the first branch pipe component 1. An end of the second assembly section 122 of the copper connecting pipe in the first branch pipe component 1 is also basically flush with an end of the stainless steel pipe 21 in the second branch pipe component 2 in an axial direction. For example, in FIG. 7, the copper connecting pipe 22 in the second branch pipe component is inserted into the copper connecting pipe 12 in the first branch pipe component. However, any limitation is not made thereto in the present invention. In other embodiments, the copper connecting pipe 12 in the first branch pipe component can alternatively be inserted into the copper connecting pipe 22 in the second branch pipe component, as shown in FIG. 8.

In a client refrigeration system, an end of the liquid distributor branch pipe needs to be connected to a corresponding branch of a heat exchanger to implement refrigerant distribution. Due to a limited distribution position of the heat exchanger branch in the refrigeration system, the liquid distributor branch pipe usually needs to be bent during installation to change an end orientation of the liquid distributor branch pipe. For ease of bending the liquid distributor branch pipe, in this embodiment, an outer diameter of a stainless steel pipe in at least one branch pipe component is set to be greater than or equal to 2 mm and less than or equal to 4.5 mm, with a wall thickness greater than or equal to 0.18 mm and less than or equal to 0.52 mm. Within the ranges of pipe diameter and wall thickness, the stainless steel pipes have excellent forming and processing capabilities, enabling the end of the liquid distributor branch pipe to be well assembled on the heat exchanger pipeline in the refrigeration system. Further, with a same wall thickness, as the outer diameter of the stainless steel pipe is smaller, an inner diameter thereof is smaller. The refrigerant can maintain a high flow velocity inside the stainless steel pipe, effectively improving the heat transfer efficiency of the heat exchanger at a back end.

Specifically, in this embodiment, an outer diameter of the stainless steel pipe 21 in the second branch pipe component 2 located away from the liquid distributor body is greater than or equal to 2 mm and less than or equal to 4.5 mm, and a wall thickness of the stainless steel pipe 21 is greater than or equal to 0.18 mm and less than or equal to 0.52 mm. The stainless steel pipe 11 inside the first branch pipe component 1 has a greater diameter to allow the refrigerant uniformly mixed by the liquid distributor body to quickly enter the first branch pipe component 1. Preferably, the outer diameter and wall thickness of the stainless steel pipe 21 is set to any one of the following specifications: φ3.0 mm*0.3 mm, φ3.3 mm*0.3 mm, or φ3.6 mm*0.3 mm. However, any limitation is not made thereto in the present invention. In other embodiments, the stainless steel pipe inside the first branch pipe component can alternatively be set to meet the above outer diameter and wall thickness requirements. Alternatively, the stainless steel pipes inside the two branch pipe components can meet the above outer diameter and wall thickness requirements.

Further, for liquid distributor branch pipes with soft connection sections, bent parts can be installed on the soft connection sections and/or stainless steel pipes based on pipeline layout requirements of the client refrigeration system during installation, so that an end of the liquid distributor branch pipe can match a corresponding heat exchanger branch interface without interfering with other pipelines, providing extremely flexible and easy installation.

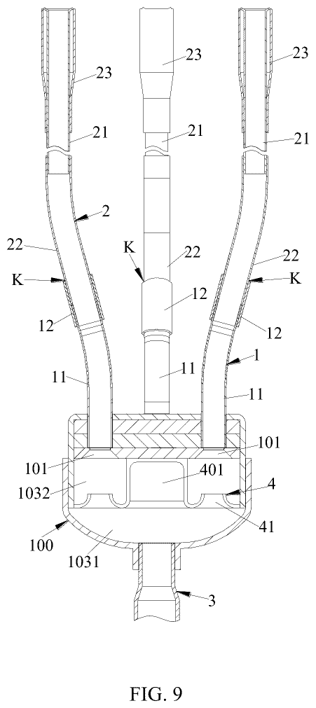

In the liquid distributor branch pipe structure provided in this embodiment, an end, of the second branch pipe component 2, far away from the liquid distributor body, is connected to an external pipeline, such as a copper heat exchanger pipeline connected to the refrigeration system. Therefore, in this embodiment, the second branch pipe component 2 is disposed to further include a copper connection section 23 that is welded to the other end of the stainless steel pipe 21 opposite to the copper connecting pipe 22 inside the branch pipe component and that is used for connecting an external pipeline, as shown in FIG. 9. However, any limitation is not made thereto in the present invention. In other embodiments, when the liquid distributor branch pipe structure is connected to an aluminum heat exchanger, the second branch pipe component may further include an aluminum connection section.

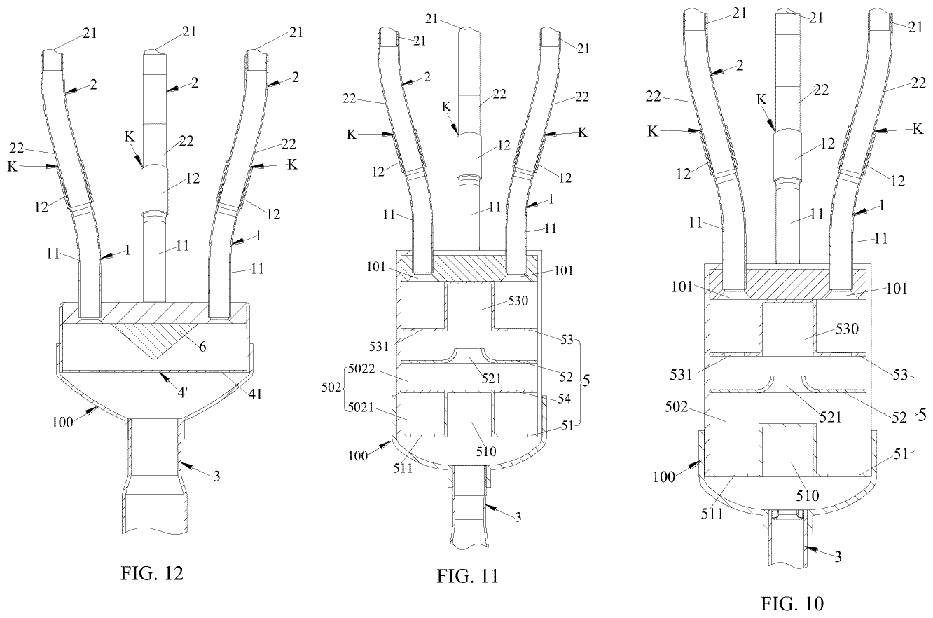

Correspondingly, this embodiment further provides a liquid distributor, including a liquid distributor body 100 and the above liquid distributor branch pipe structure. The liquid distributor body 100 is a stainless steel liquid distributor body or a liquid distributor body mainly made of a stainless steel material. As shown in FIG. 9, the liquid distributor body 100 provided in this embodiment is a structure that integrates reflection and mixing. A baffle 4 is disposed inside the liquid distributor body 100. A cavity 401 with an opening facing a liquid inlet hole is formed on a region opposite to a liquid inlet pipe 3 on the baffle 4, and the baffle 4 at the cavity 401 protrudes and extends towards a side on which a connecting pipe hole 101 is located. The baffle 4 divides an internal cavity of the liquid distributor body into a reflective mixing region 1031 near the liquid inlet end and including the cavity 401 and a mixing and distribution region 1032 near a liquid outlet end. A plurality of baffle holes 41 are formed in the baffle 4, which are distributed in a circular shape around an axis of the liquid distributor body 100 and communicate the reflective mixing region 1031 and the mixing and distribution region 1032. The plurality of baffle holes 41 are used to be in a one-to-one correspondence with the plurality of connecting pipe holes 101, and the plurality of baffle holes 41 are located on an outer periphery of a liquid outlet end of the liquid inlet pipe 3 when projected along an axial direction of the liquid distributor body 100. However, the present invention does not limit a structure of the liquid distributor body in any manner. The liquid distributor branch pipe structure provided in this embodiment is also applicable to a liquid distributor body 100 of other structures, as shown in FIG. 10 to FIG. 22.

In FIG. 10, a two-stage jet reflective mixing component 5 is disposed inside the liquid distributor body 100. The two-stage jet reflective mixing component 5 includes a first-stage reflective mixing plate 51, a second-stage jet hole plate 52, and a second-stage reflective mixing plate 53, which are distributed in an inner cavity of the liquid distributor body 100 at intervals along a flowing direction of a refrigerant. The first-stage reflective mixing plate 51 is distributed opposite to the liquid inlet pipe 3 to reflect and mix the refrigerant injected into the liquid inlet pipe 3. A plurality of flow passage holes 511 are formed in the first-stage reflective mixing plate 51. The second-stage jet hole plate 52 and the first-stage reflective mixing plate 51 enclose a jet chamber 502, and a second-stage jet hole 521 is formed in the second-stage jet hole plate 52. A refrigerant reflected and mixed on the first-stage reflective mixing plate 51 is collected in the jet chamber 502 through the flow passage holes 511 and injected into the second-stage reflective mixing plate 53 through the second-stage jet hole 521. The second-stage reflective mixing plate 53 is distributed opposite to the second-stage jet hole 521 and is provided with a plurality of flow guide holes 531 with a same quantity as the connecting pipe holes 101. Each flow guide hole 531 is basically coaxial with a corresponding connecting pipe hole 101. The second-stage reflective mixing plate 53 reflects and mixes the refrigerant injected from the second-stage jet hole 521, and then distributes the refrigerant to the plurality of connecting pipe holes 101 through the flow guide holes 531. Specifically, in FIG. 10, a position, at which the first-stage reflective mixing plate 51 is opposite to the liquid inlet pipe 3, protrudes and extends towards a side on which the second-stage jet hole plate 52 is located, to form a first-stage reflective cavity 510 with an opening facing the liquid outlet end of the liquid inlet pipe 3. A second-stage reflective cavity 530 is formed on the second-stage reflective mixing plate 53. However, any limitation is not made thereto in the present invention.

Structures in FIG. 11 and FIG. 10 are basically the same, but a difference is that the liquid distributor body 100 shown in FIG. 11 further includes a chamber baffle 54 located on a downstream side of the first-stage reflective mixing plate 51. The chamber baffle 54 divides the jet chamber 502 into an upstream chamber 5021 and a downstream chamber 5022. The upstream chamber 5021 is an annular chamber surrounding the first-stage reflective cavity 510, and the downstream chamber 5022 communicates the second-stage jet hole 521. Baffle through holes (not shown in FIG. 11 due to a viewing angle) distributed with the plurality of flow passage holes 511 in a staggered manner are formed in the chamber baffle 54.

In FIG. 12, a flat-plate baffle 4′and a conical flow channel forming component 6 are formed inside the liquid distributor body 100. A plurality of baffle holes 41 are formed in the flat-plate baffle 4′.

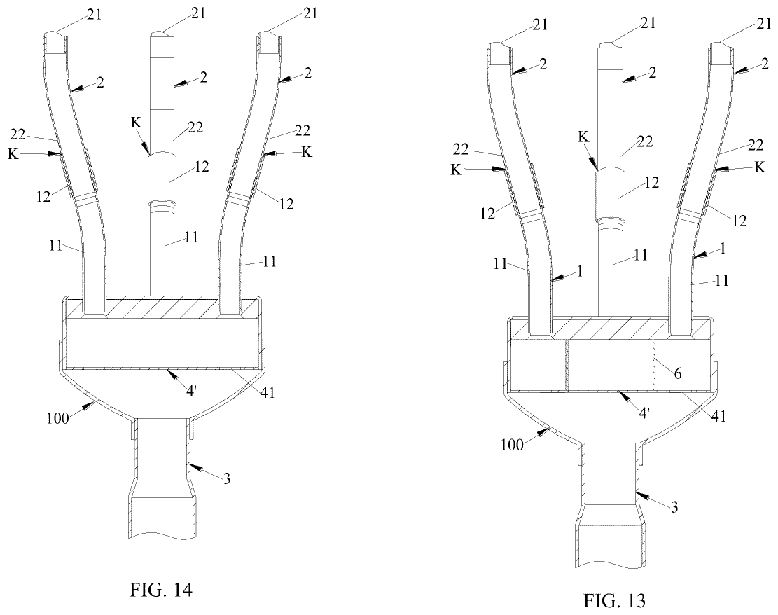

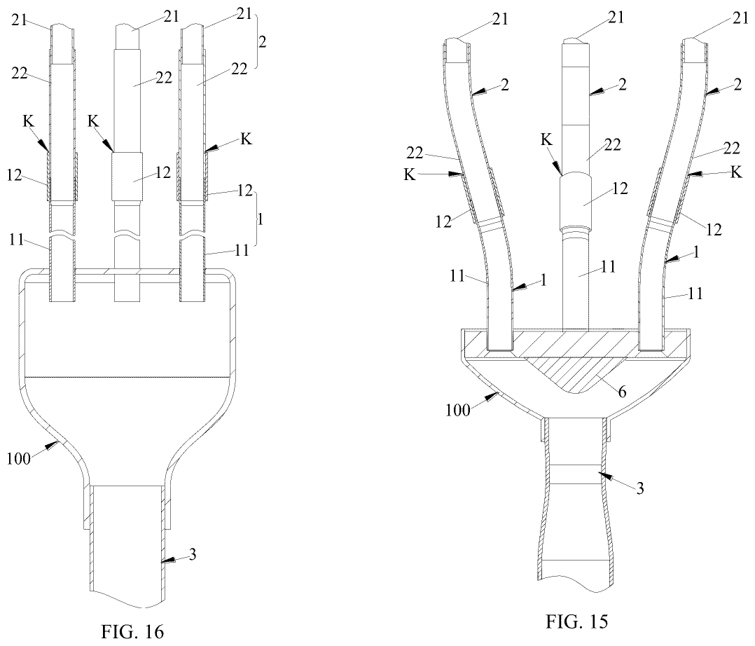

A structure in FIG. 13 is basically the same as a structure in FIG. 12, with a difference as follows: in FIG. 13, the channel flow channel forming component 6 is a sleeve with a cross-section that remains basically unchanged along an extension direction. In FIG. 14, only the flat-plate baffle 4′ is formed inside the liquid distributor body 100. In FIG. 15, only the flow channel forming component 6 is formed inside the liquid distributor body 100. In this structure, a Venturi pipe section is formed on the liquid inlet pipe 3, and a throat-like part of the Venturi pipe section accelerates a refrigerant and sprays an accelerated refrigerant into the flow channel forming component 6.

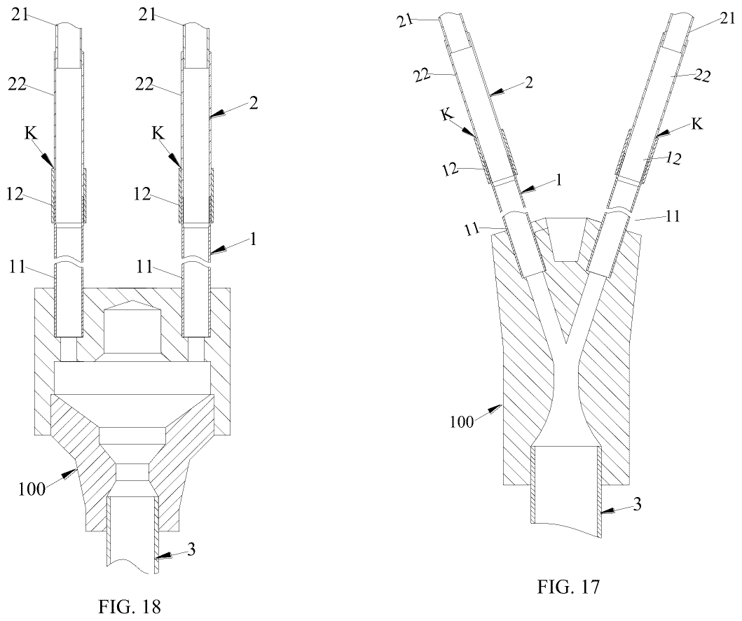

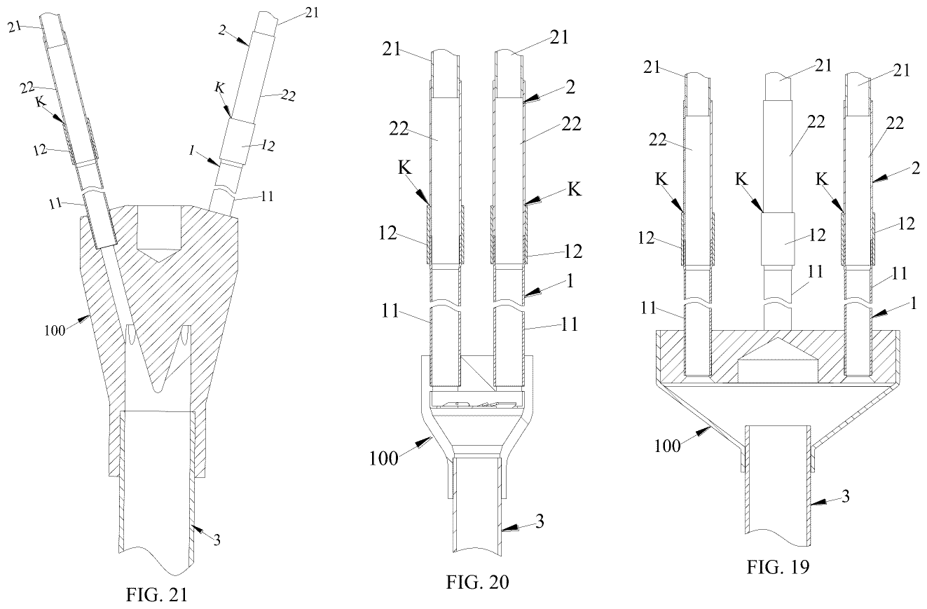

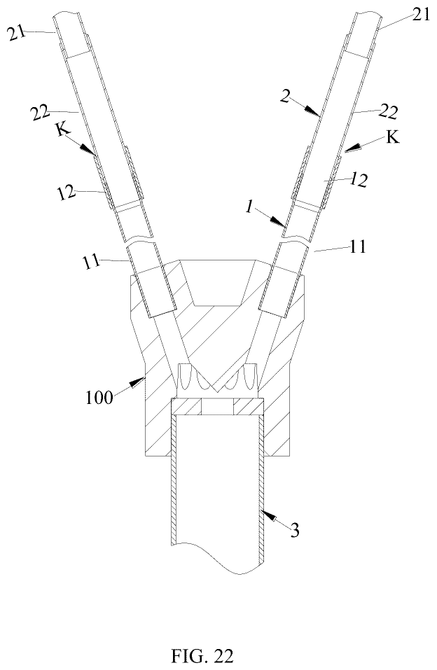

A liquid distributor body 100 in FIG. 16 has an insert-type structure; a liquid distributor body 100 in FIG. 17 has a Venturi structure; a liquid distributor body 100 in FIG. 18 has a Venturi pipe structure; a liquid distributor body 100 in FIG. 19 has a reflective structure; a liquid distributor body 100 in FIG. 20 has a blade-shaped structure; a liquid distributor body 100 in FIG. 21 has a conical structure; and a liquid distributor body 100 in FIG. 22 has a perforated plate structure. The present invention does not list specific structures of the liquid distributor bodies one by one. Other liquid distributor body structures that can improve the uniformity of liquid distribution can be combined with the liquid distributor branch pipe structure provided in this embodiment. Similarly, a structure of the liquid inlet pipe 3 is not limited in any manner in the present invention, and the liquid inlet pipe 3 can be any of a pipe fitting, a Venturi pipe, a throttling hole pipe, or a hole-plate-type structure with basically the same inner diameter.

### Second Embodiment

This embodiment is basically the same as the first embodiment with basically the same variations, with a difference as follows: in a liquid distributor branch pipe structure provided in this embodiment, an excess solder storage region 202 in a sleeving gap 20 formed by mutual sleeving of second assembly sections 122, 222 of two copper connecting pipes is provided, to form an anti-solder blockage design.

Compared with furnace brazing for integrally heating a base material, only the base material is usually locally heated through non-furnace brazing. During local heating, a mass of a base material on both sides of a joint affects heat absorption, and as the mass of the base material is greater, the base material needs to absorb more heat. In a traditional copper liquid distributor, copper branch pipes are connected to a plurality of branch pipe holes in a liquid distributor body through flame brazing. A mass of the liquid distributor body is greater than a mass of the copper branch pipes, and more heat needs to be absorbed during brazing, resulting in longer welding heating time. The brazing solder absorbs excessive heat (also known as overburning) and causes flow welding, which blocks an end of an inserted copper connecting pipe. In the liquid distributor branch pipe structure provided in this embodiment, wall thicknesses of the two copper connecting pipes 12 and 22 are basically similar, but pipe diameters of the two copper connecting pipes 12 and 22 are different. A copper connecting pipe with a larger diameter has greater mass and therefore absorbs more heat, and a brazing solder is also prone to flow welding due to overburning during brazing. Further, due to a large quantity of branch pipes in the liquid distributor and a small spacing between the branch pipes, during flame brazing or other non-furnace brazing, welding heat is inevitably transferred to adjacent branch pipes that have already been welded, resulting in overburning of the adjacent branch pipes and flow welding blockage. In addition, factors such as a sleeving gap between two copper connecting pipes, precision of controlling welding operation duration, and a wire feeding speed can all cause welding blockage.

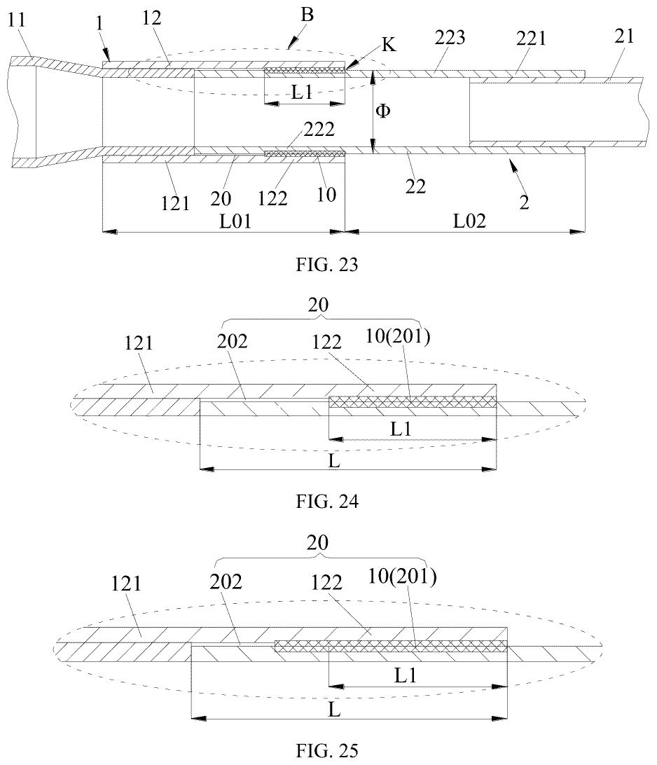

To resolve the problem of welding blockage caused by non-furnace brazing, this embodiment provides the liquid distributor branch pipe structure with an anti-welding blockage design. As shown in FIG. 23, a second assembly section 122 of a copper connecting pipe in a first branch pipe component 1 and a second assembly section 222 of a copper connecting pipe in a second branch pipe component 2 are sleeved to form a sleeving gap 20. A welding position of non-furnace brazing (such as flame brazing) is located at an arrow position K in FIG. 23. During brazing, a brazing solder gradually penetrates from the welding position K into the sleeving gap 20 to form a brazed layer 10. Therefore, an extension direction of the brazed layer 10 is from the welding position K to the sleeving gap 20. In this embodiment, as shown in FIG. 24, the sleeving gap 20 includes an effective depth region 201 of the brazed layer and an excess solder storage region 202 distributed along an extension direction of the brazed layer 10. The effective depth region 201 of the brazed layer means a brazing solder filling region formed after the second assembly sections 122, 222 of the two copper connecting pipes through non-furnace brazing (such as flame brazing) to meet pressure requirements of a refrigeration system. To be specific, a length of the brazed layer 10 needs to be greater than or equal to a length L1 of the effective depth region 201 of the brazed layer. An effective depth (namely, a length of the effective depth region 201 of the brazed layer) of the brazed layer within the sleeving gap 20 is L1≥0.4 Φ, where Φ is an outer diameter of an inserted copper connecting pipe of the two copper connecting pipes. In FIG. 23, Φ is an outer diameter of a copper connecting pipe 22 in the second branch pipe component 2, and L is a length of the sleeving gap 20.

FIG. 23 and FIG. 24 are schematic structural diagrams in which the brazed layer 10 extends just to an end of the effective depth region 201 of the brazed layer. This schematic structural diagram is a schematic structural diagram formed under ideal welding conditions. However, when the liquid distributor branch pipe structure undergoes flow welding due to an excess brazing solder, overburning, or secondary welding melting, the brazing solder seeps out from the effective depth region 201 of the brazed layer and enters the excess solder storage region 202. Namely, the brazed layer 10 extends into the excess solder storage region 202, as shown in FIG. 25. The excess solder storage region 202 provides excess space for the brazing solder generated by excess or flow soldering to form an anti-solder blockage design. However, any limitation is not made thereto in the present invention. In other embodiments, under ideal welding conditions, the brazed layer can alternatively extend only to a place near the effective depth region of the brazed layer.

In this embodiment, the anti-solder blockage design is described based on the liquid distributor branch pipe structure shown in the first embodiment. However, any limitation is not made thereto in the present invention. The anti-solder blockage design provided in this embodiment can also be used for a liquid distributor branch pipe structure (as shown in FIG. 3 to FIG. 8) provided in other embodiments. To be specific, a sleeving gap is set to include an effective depth region of a brazed layer and an excess solder storage region distributed along an extension direction of the brazed layer. The effective depth (namely, the length of the effective depth region of the brazed layer) of the brazed layer is L1≥0.4 Φ, where Φ is an outer diameter of an inserted copper connecting pipe of the two copper connecting pipes, which is not described again in this embodiment.

Similar to the first embodiment, the liquid distributor branch pipe structure provided in this embodiment can alternatively be assembled and welded with various stainless steel liquid distributor bodies (or liquid distributor bodies mainly made of a stainless steel material) to form liquid distributors with various structures, as shown in FIG. 9 to FIG. 22.

### Third Embodiment

This embodiment is basically the same as the first embodiment with basically the same variations, with a difference as follows: In an extension direction of a brazed layer 10, a solder accommodating chamber 30 is formed, between two branch pipe components, at an end of a sleeving gap 20 and for accommodating a brazing solder. The solder accommodating chamber 30 is used to store an excess brazing solder or a brazing solder generated by flow soldering, to form an anti-solder blockage design.

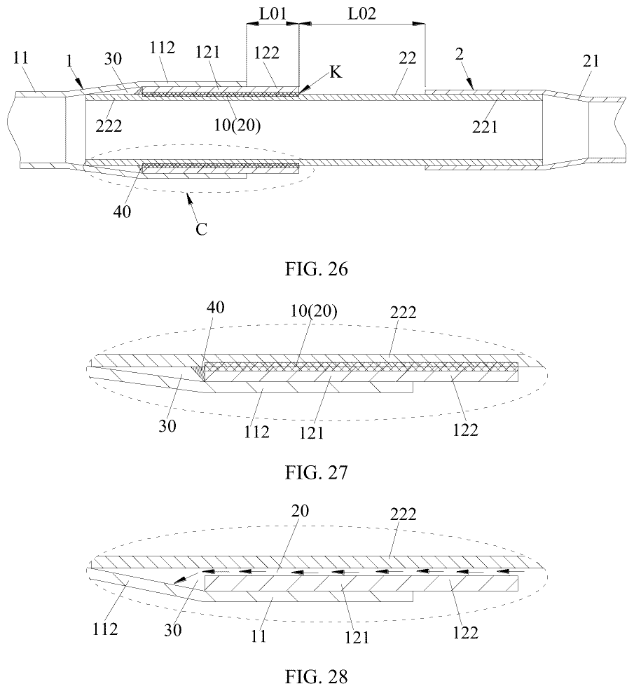

Specifically, as shown in FIG. 26 and FIG. 27, in a first branch pipe component 1, a flared section 112 is formed at an end of a stainless steel pipe 11, and a first assembly section 121 of a copper connecting pipe 12 is inserted into the flared section 112. When two branch pipe components are assembled, a second assembly section 222 of a copper connecting pipe in a second branch pipe component 2 is inserted into a second assembly section 122 of a copper connecting pipe in the first branch pipe component 1, and an inserted end extends into the flared section 112 of the stainless steel pipe 11. In this structure, the second assembly section 122 of the copper connecting pipe 12 is welded to only the second assembly section 222 of the copper connecting pipe 22. When non-furnace brazing is performed, a welding gun at a welding position K needs to heat only the second assembly sections 122, 222 of the two copper connecting pipes. However, in this embodiment, the first assembly section 121 of the copper connecting pipe 12 is not only connected to a corresponding stainless steel pipe 11, but also brazed to the second assembly section 222 of the copper connecting pipe 22.

In this embodiment, a position of the sleeving gap 20 is filled with the brazed layer 10, and the position of the sleeving gap 20 is a position of the brazed layer 10. An end of the first assembly section 121 of the copper connecting pipe in the first branch pipe component 1, an inclined inner peripheral wall of the flared section 112 of the stainless steel pipe, and an outer peripheral wall of the second assembly section 222 of the copper connecting pipe in the second branch pipe component 2 jointly enclose the solder accommodating chamber 30 located at the end of the sleeving gap 20. As indicated by an arrow in FIG. 28, when there is an excess brazing solder, overburning, or secondary welding melting, the brazing solder inevitably penetrates from the sleeving gap 20. The excess brazing solder can enter and be stored in the solder accommodating chamber 30 through the sleeving gap 20, and does not penetrate to the end of the second assembly section 222 of the copper connecting pipe in the second branch pipe component 2, causing welding blockage. Further, the stored excess brazing solder can also form another brazed layer 40 between an end of the first assembly section 121 of the copper connecting pipe in the first branch pipe component 1 and the outer peripheral wall of the second assembly section 222 of the copper connecting pipe in the second branch pipe component 2, to increase a welding strength.

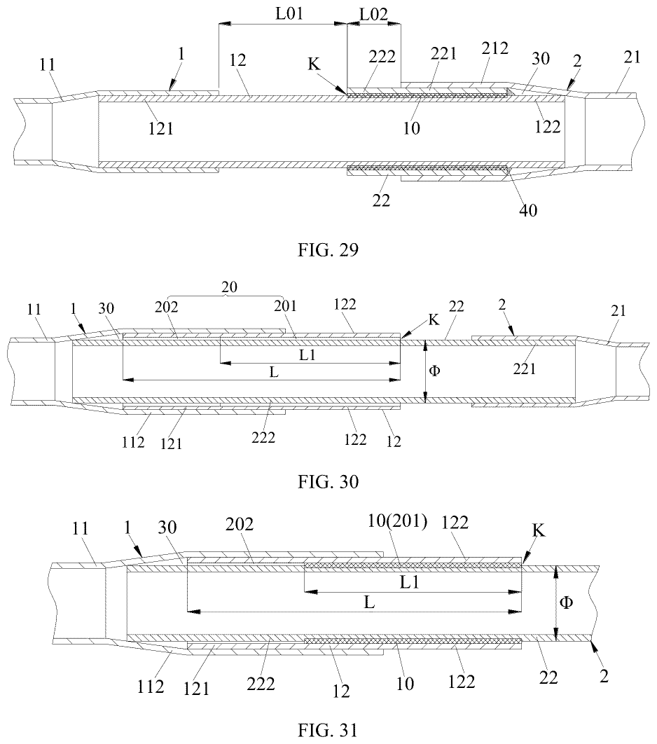

In this embodiment, for example, the copper connecting pipe 22 in the second branch pipe component extends into the stainless steel pipe 11 in the first branch pipe component, to form the solder accommodating chamber 30. However, any limitation is not made thereto in the present invention. In other embodiments, as shown in FIG. 29, the second assembly section 122 of the copper connecting pipe in the first branch pipe component 1 connected to the liquid distributor body can also be inserted into the copper connecting pipe 22 of the second branch pipe component 2, and an inserted end extends into the flared section 212 of the corresponding stainless steel pipe 21, to form the solder accommodating chamber 30.

In the liquid distributor branch pipe structure provided in this embodiment, an inclined peripheral wall of the flared section 112 at the end of the stainless steel pipe 11 enables the solder accommodating chamber 30 to be a closed annular chamber. However, any limitation is not made thereto in the present invention. In other embodiments, a peripheral wall of a pipe fitting enclosing the solder accommodating chamber can alternatively be a circular arc peripheral wall or a combination of the circular arc peripheral wall and a straight section peripheral wall. Alternatively, the solder accommodating chamber may be an open chamber.

### Fourth Embodiment

This embodiment is basically the same as the third embodiment with basically the same variations, with a difference as follows: as shown in FIG. 30, a sleeving gap 20 includes an effective depth region 201 of a brazed layer and an excess solder storage region 202 distributed along an extension direction of the brazed layer 10, and the excess solder storage region 202 and the solder accommodating chamber 30 form a secondary anti-solder blockage design.

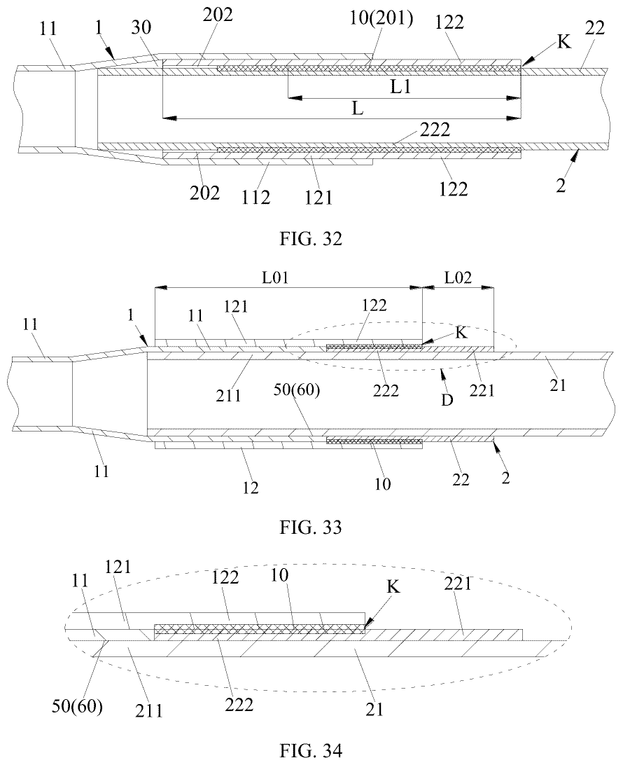

FIG. 31 is a schematic structural diagram in which the brazed layer 10 extends just to an end of the effective depth region 201 of the brazed layer. This schematic structural diagram is a schematic structural diagram formed under ideal welding conditions. However, when the liquid distributor branch pipe structure undergoes flow welding due to an excess brazing solder, overburning, or secondary welding melting, the brazing solder seeps out from the effective depth region 201 of the brazed layer and enters the excess solder storage region 202. Namely, the brazed layer 10 extends into the excess solder storage region 202, as shown in FIG. 32. The excess solder storage region 202 provides excess space for the brazing solder generated by excess or flow soldering to form a primary anti-solder blockage design. Further, when the excess solder storage region 202 is filled, the brazing solder enters the solder accommodating chamber 30, and a secondary anti-solder blockage design is formed at a position of the solder accommodating chamber 30, to effectively prevent the brazing solder from blocking a refrigerant flow channel in the liquid distributor branch pipe.

### Fifth Embodiment

As described in the second embodiment, a base material is locally heated during non-furnace brazing. Due to different heat absorption of the base material on both sides of a welded joint, the brazing solder is prone to overburning, causing flow welding. In addition, due to characteristics of a plurality of branch pipes and a small spacing between the branch pipes in the liquid distributor, precision of controlling welding during, a wire feeding speed, and the like, flow welding inevitably occurs on the brazing solder during non-furnace brazing, further causing welding blockage.

Based on a same design concept, this embodiment further provides another type of liquid distributor branch pipe structure that can be efficiently brazed in the air after stainless steel treatment and can effectively prevent welding blockage. The liquid distributor branch pipe structure includes two branch pipe components. Each branch pipe component includes a stainless steel pipe and a copper connecting pipe welded to an end of the stainless steel pipe, and a stainless steel pipe on one of the branch pipe components is welded to a liquid distributor body. Copper connecting pipes on the two branch pipe components are sleeved, and a brazed layer 10 formed by non-furnace brazing is formed in a sleeving gap. A stainless steel pipe in one branch pipe component extends out of a corresponding copper connecting pipe to form a stainless steel extension section, and the stainless steel extension section extends into the other branch pipe component. A blocking region 50 is formed at an assembly gap or a spacing chamber between an outer peripheral wall of the stainless steel extension section and an inner peripheral wall of the other branch pipe component, to block extension of the brazed layer 10 towards an end surface of the stainless steel extension section.

Similar to the first embodiment, in the liquid distributor branch pipe structure provided in this embodiment, the copper connecting pipes 12 and 22 are disposed to provide conditions for efficient, low-cost, and flexible non-furnace brazing of the two branch pipe components 1 and 2 after stainless steel treatment. This welding manner also allows each branch pipe component to be separately processed or assembled with other components for processing, greatly improving flexibility and efficiency of processing of the branch pipe components. The efficient processing of the branch pipe components and subsequent rapid non-furnace brazing enable the liquid distributor branch pipe structure provided in this embodiment to be efficient and flexible in production, and can be well adapted to small batch customization of liquid distributors with various categories and various specifications. Further, unlike the second embodiment and third embodiment in which the solder accommodating chamber and/or the excess solder storage region are used for the anti-solder blockage design, the blocking region 50 is formed based on the stainless steel extension section in this embodiment. The blocking region 50 can effectively block a flow path of the brazing solder to prevent flow welding, thereby resolving a problem of welding blockage.

For ease of description, the copper connecting pipe 12 inside the first branch pipe component 1 is defined to include a first assembly section 121 and a second assembly section 122; and the copper connecting pipe 22 inside the second branch pipe component 2 also includes a first assembly section 221 and a second assembly section 222. The second assembly sections 122, 222 of the two branch pipe components are sleeved and welded through the brazed layer 10.

Specifically, as shown in FIG. 33 and FIG. 34, in this embodiment, the stainless steel pipe 21 inside the second branch pipe component 2 extends out of a second assembly section 222 of a corresponding copper connecting pipe 22 to form a stainless steel extension section 211. When the two copper connecting pipes 12 and 22 are sleeved and assembled, the stainless steel extension section 211 is inserted into the stainless steel pipe 11 of the first branch pipe component 1, and an end surface of the second assembly section 222 of the copper connecting pipe 22 abuts against an end surface of the stainless steel pipe 11 of the first branch pipe component 1. The blocking region 50 is formed at an assembly gap 60 between the outer peripheral wall of the stainless steel extension section 211 and an inner peripheral wall of the stainless steel pipe 11 in the first branch pipe component, to block the brazed layer 10 from extending towards an end surface of the stainless steel extension section 211, thereby effectively preventing welding blockage.

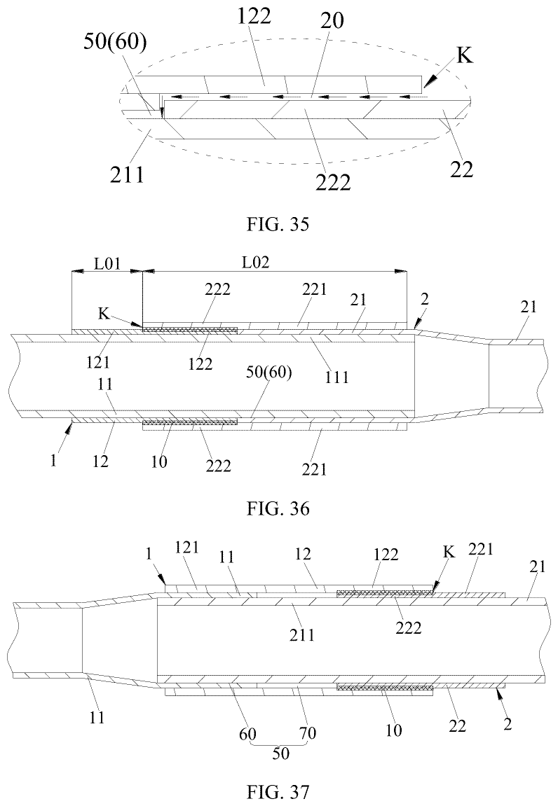

As shown in FIG. 35, a welding position of non-furnace brazing (such as flame brazing) is located at K, and the brazing solder penetrates along the sleeving gap 20 between the two copper connecting pipes 12, 22 to an end of the second assembly section 222 of the copper connecting pipe 22 in the second branch pipe component 2, as indicated by an arrow. In this case, the brazing solder enters the assembly gap 60 (namely, within the blocking region 50) between the stainless steel extension section 211 and an inner peripheral wall of the stainless steel pipe 11. In the air, stable and dense oxide films such as Cr₂O₃ (chromium sesquioxide) and TiO₂ (titanium dioxide) are formed on a surface of the stainless steel extension section 211. During welding, it is difficult for the brazing solder to wet these oxide films which cannot spread on the surface of the stainless steel extension section 211. A penetration path of the brazing solder is blocked at this position and cannot continue to extend towards the end surface of the stainless steel extension section 211. To be specific, an end of the stainless steel extension section 211 that serves as an input end of the second branch pipe component 2 is not blocked.

A surface of a stainless steel material is prone to oxidation, and an oxide film formed after oxidation has a high melting point and is difficult to remove, which makes it difficult to directly solder the material in the air. The liquid distributor branch pipe structure provided in this embodiment also precisely uses the characteristic of the stainless steel material. The stainless steel extension section 211 is disposed to form the blocking region 50 for blocking the penetration path of the brazing solder, effectively resolving a welding blockage problem easily caused by brazing in the air. In addition, the blocking region 50 blocks the penetration path of the brazing solder, allowing the brazing solder to penetrate only into the sleeving gap 20 at any time, so that flow welding does not occur even in case of overburning or secondary melting. A uniform, continuous, and full brazed layer 10 can always be formed within the sleeving gap 20, ensuring that a connection strength and sealing performance of the brazed layer 10 can meet requirements of a refrigeration system well. In addition, the stainless steel extension section 211 extends into the stainless steel pipe 11 of the first branch pipe component 1. This disposing also ensures that the copper connecting pipes 12 and 22 in the two branch pipe components are not individually pressurized at any position. The liquid distributor branch pipe structure has good pressure resistance and can be used in a high-pressure refrigeration system. In addition, wall thicknesses of the copper connecting pipes 12 and 22 are not limited by a pressure of the refrigeration system, and are designed to meet only requirements of non-furnace brazing (such as flame brazing). Therefore, thin copper connecting pipe fittings can be selected to further reduce material costs.

In this embodiment, for example, the stainless steel pipe 21 in the second branch pipe component 2 connected to an external pipeline extends out of a corresponding copper connecting pipe 22 to form the stainless steel extension section 211. However, any limitation is not made thereto in the present invention. In other embodiments, as shown in FIG. 36, the stainless steel pipe 11 in the first branch pipe component 1 connected to the liquid distributor body extends out of the second assembly section 122 of the corresponding copper connecting pipe 12 to form the stainless steel extension section 111. In this structure, the stainless steel extension section 111 is inserted into the second branch pipe component 2, and the blocking region 50 is formed at the assembly gap or a spacing chamber between the outer peripheral wall of the stainless steel extension section 111 and the inner peripheral wall of the second branch pipe component 2 to block the brazed layer 10 from extending towards the end surface of the stainless steel extension section 111, thereby forming an anti-solder blockage and anti-flow welding design. Specifically, the stainless steel extension section 111 extends into the stainless steel pipe 21 of the second branch pipe component 2, and an end of the second assembly section 122 of the copper connecting pipe in the first branch pipe component 1 abuts against an end of the stainless steel pipe 21 in the second branch pipe component 2. The blocking region 50 is the assembly gap 60 between the outer peripheral wall of the stainless steel extension section 111 and the inner peripheral wall of the stainless steel pipe 21.

However, the present invention does not limit a manner for forming the blocking region 50 in any way. FIG. 37 to FIG. 40 are partial schematic diagrams of the liquid distributor branch pipe structure according to another embodiment of the present invention.

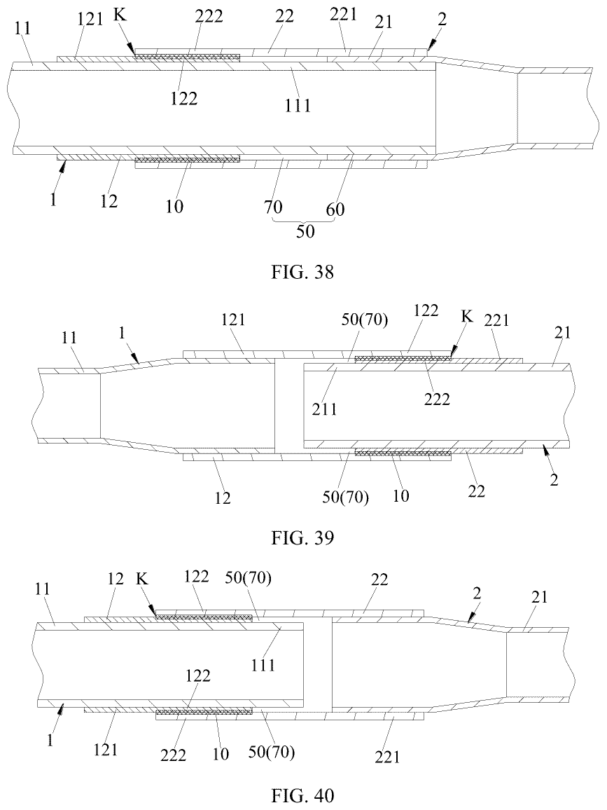

As shown in FIG. 37, in this structure, the stainless steel extension section 211 inside the second branch pipe component 2 still extends into the stainless steel pipe 11 of the first branch pipe component 1. However, in this case, the end surface of the second assembly section 222 of the copper connecting pipe 22 corresponding to the stainless steel extension section 211 does not abut against the end surface of the stainless steel pipe 11 inside the first branch pipe component 1. The blocking region 50 includes a spacing chamber 70 between the outer peripheral wall of the stainless steel extension section 211 and the inner peripheral wall of the copper connecting pipe 12 in the first branch pipe component 1, as well as an assembly gap 60 between the outer peripheral wall of the stainless steel extension section 211 and the inner peripheral wall of the stainless steel pipe 11 in the first branch pipe component 1. A structure shown in FIG. 38 is basically the same as the structure shown in FIG. 37, in which the stainless steel extension section is formed inside the first branch pipe component 1 connected to the liquid distributor body. Specifically, the stainless steel pipe 11 inside the first branch pipe component 1 extends into the corresponding copper connecting pipe 12 to form the stainless steel extension section 111. The stainless steel extension section 111 extends into the stainless steel pipe 21 of the second branch pipe component 2. However, an end surface of the second assembly section 122 of the copper connecting pipe 12 in the first branch pipe component 1 does not abut against an end of the stainless steel pipe 21 in the second branch pipe component. Therefore, the blocking region 50 is the spacing chamber 70 between the stainless steel extension section 111 and the inner peripheral wall of the copper connecting pipe 22 in the second branch pipe component 2, and the assembly gap 60 between the stainless steel extension section 111 and the inner peripheral wall of the stainless steel pipe 21 in the second branch pipe component 2.

FIG. 39 is another liquid distributor branch pipe structure. In this structure, a stainless steel extension section 211 inside a second branch pipe component 2 extends into a second assembly section 122 of a copper connecting pipe inside a first branch pipe component, and a blocking region 50 is a spacing chamber 70 between an outer peripheral wall of the stainless steel extension section 211 and an inner peripheral wall of a copper connecting pipe 12 inside the first branch pipe component 1. A structure shown in FIG. 40 is basically the same as the structure shown in FIG. 35, in which the stainless steel extension section 111 is formed inside the first branch pipe component 1 connected to the liquid distributor body. Specifically, the stainless steel extension section 111 in the first branch pipe component 1 extends into the second assembly section 222 of the copper connecting pipe 22 in the second branch pipe component 2, and the blocking region 50 is the spacing chamber 70 between the stainless steel extension section 111 and the inner peripheral wall of the copper connecting pipe 22 in the second branch pipe component 2.

Similar to the first embodiment 1, flame brazing is also used in this embodiment to form a brazed layer 10 by connecting two copper connecting pipes 12, 22. However, any limitation is not made thereto in the present invention. In other embodiments, other non-furnace brazing manners such as induction brazing, arc brazing, laser brazing, or electron beam brazing can alternatively be used to form the brazed layer in the air.

Similarly, to prevent a decrease in the performance of stainless steel pipes caused by direct radiation of welding heat to surfaces of the stainless steel pipes on both sides during brazing, a shortest axial spacing from an end of a second assembly section of a sleeving copper connecting pipe to an exposed region of each stainless steel pipe is greater than or equal to Φ, where Φ is an outer diameter of an inserted copper connecting pipe. In this embodiment, as shown in FIG. 33, an end of the second assembly section of the sleeving copper connecting pipe is an end of the second assembly section 122 of the copper connecting pipe 12 inside the first branch pipe component 1. The copper connecting pipes in the two branch pipe components are sleeved on corresponding stainless steel pipes, and exposed regions of the stainless steel pipes are outer peripheral walls of stainless steel pipes at ends of first assembly sections of the corresponding copper connecting pipes respectively. Therefore, as shown in FIG. 33, an axial distance L01 is an axial distance from the end of the second assembly section 122 of the copper connecting pipe 12 to an end of the first assembly section 121 of the copper connecting pipe 12. An axial distance L02 is an axial distance from the end of the second assembly section 122 of the copper connecting pipe 12 to an end of the first assembly section 221 of the copper connecting pipe 22 inside the second branch pipe component. Similarly, in FIG. 36 with a similar structure, the sleeving copper connecting pipe is the copper connecting pipe 22 in the second branch pipe component. An axial distance L01 is an axial distance from the end of the second assembly section 222 of the copper connecting pipe 22 to an end of the first assembly section 121 of the copper connecting pipe 12. An axial distance L02 is an axial distance from the end of the second assembly section 222 of the copper connecting pipe 22 to an end of the first assembly section 221 of the copper connecting pipe 22 inside the second branch pipe component.

Similar to the first embodiment, outer diameters of stainless steel pipes 11 and 21 in the two branch pipe components are greater than or equal to 2 mm and less than or equal to 4.5 mm, and wall thicknesses thereof are greater than or equal to 0.18 mm and less than or equal to 0.52 mm. However, any limitation is not made thereto in the present invention. In other embodiments, a stainless steel pipe inside one of the branch pipe components can alternatively be set to meet the diameter requirement. Similarly, a stainless steel pipe in each branch pipe component can be either a straight pipe or a bent pipe.

Similarly, a branch pipe component away from the liquid distributor body may also include a copper connection section welded to the other end of the stainless steel pipe opposite to the copper connecting pipe and configured to connect an external pipeline. However, any limitation is not made thereto in the present invention. In other embodiments, when the liquid distributor branch pipe structure is connected to an aluminum heat exchanger, the second branch pipe component may further include an aluminum connection section.

Similar to the first embodiment, the liquid distributor branch pipe structure provided in this embodiment can alternatively be assembled and welded with various stainless steel liquid distributor bodies (or liquid distributor bodies mainly made of a stainless steel material) to form liquid distributors with various structures, as shown in FIG. 9 to FIG. 22.

In summary, the liquid distributor branch pipe structure provided in the present invention includes two branch pipe components, and each of the two branch pipe components includes the stainless steel pipe and the copper connecting pipe. The copper connecting pipes inside the two branch pipe components are sleeved to form welding of a same type of metal based on a copper material. Compared with a stainless steel material, the oxide film on the surface of the copper material can be reduced and removed by adding the brazing flux. The brazing solder can also wet the surface of the copper base material well in the air and spread out, forming the dense, stable, and high-strength brazed layer. This provides conditions for simple, efficient, and flexible non-furnace brazing of a long branch pipe component after stainless steel treatment. In addition, during welding, the shortest axial distance from the end of the second assembly section of the sleeving copper connecting pipe to the exposed region of each stainless steel pipe is controlled to effectively reduce the thermal impact of welding heat on a crystal structure of the stainless steel pipe during non-furnace brazing, ensuring an excellent connection strength and pressure resistance of the stainless steel pipe after welding. Further, each copper connecting pipe is disposed to include the first assembly section welded to a corresponding stainless steel pipe and the second assembly section only sleeved with the other copper connecting pipe. Through this setting, only the second assembly sections of the two copper connecting pipes need to be heated by the welding heat during non-furnace brazing, which not only has a short heating time and high welding efficiency, but also greatly reduces input welding heat, thereby further reducing the thermal impact of the welding heat on the stainless steel pipes during non-furnace brazing.

In addition, the solder accommodating chamber can be disposed at the end of the sleeving gap between the two copper connecting pipes, the excess solder storage region can be disposed in the sleeving gap, the stainless steel extension section can be disposed on one stainless steel pipe to form the blocking region, or the like, to effectively prevent welding blockage caused by an excess solder or flow welding when two copper connecting pipes are brazed through non-furnace brazing.

The present invention has been disclosed in the preferred embodiments as described above, which is not intended to limit the present invention. Any person skilled in the art may make slight changes and modifications without departing from the spirit and scope of the present invention. Therefore, the scope of protection of the present invention shall be deemed to be the scope of protection in the claims.

1. A liquid distributor branch pipe structure, comprising two branch pipe components, wherein each branch pipe component comprises a stainless steel pipe and a copper connecting pipe welded to an end of the stainless steel pipe, and a stainless steel pipe on one of the branch pipe components is welded to a liquid distributor body;
each copper connecting pipe comprises a first assembly section welded to a corresponding stainless steel pipe and a second assembly section sleeved with only the other copper connecting pipe, a sleeving gap is formed between the two copper connecting pipes, and a brazed layer formed by non-furnace brazing is formed within the sleeving gap; and a shortest axial spacing from an end of a second assembly section of a sleeving copper connecting pipe to an exposed region of each stainless steel pipe is greater than or equal to Φ, wherein Φ is an outer diameter of an inserted copper connecting pipe.

2. The liquid distributor branch pipe structure according to claim 1, wherein at least one of the two copper connecting pipes further comprises a soft connection section located between the two assembly sections, and the soft connection section is a region, on the copper connecting pipe, that is not assembled with another pipe fitting.

3. The liquid distributor branch pipe structure according to claim 2, wherein at least one bent part is formed on the soft connection section.

4. The liquid distributor branch pipe structure according to claim 1, wherein a copper connecting pipe in each branch pipe component is sleeved on an end of a corresponding stainless steel pipe.

5. The liquid distributor branch pipe structure according to claim 1, wherein in an extension direction of the brazed layer, a solder accommodating chamber is formed, between the two branch pipe components, at an end of the sleeving gap and for accommodating a brazing solder.

6. The liquid distributor branch pipe structure according to claim 5, wherein the sleeving gap comprises an effective depth region of the brazed layer and an excess solder storage region distributed along an extension direction of the brazed layer; and an effective depth of the brazed layer is L1≥0.4 Φ, wherein Φ is an outer diameter of the inserted copper connecting pipe of the two copper connecting pipes.

7. The liquid distributor branch pipe structure according to claim 1, wherein the sleeving gap comprises an effective depth region of the brazed layer and an excess solder storage region distributed along an extension direction of the brazed layer; and an effective depth of the brazed layer is L1≥0.4 Φ, wherein Φ is an outer diameter of the inserted copper connecting pipe of the two copper connecting pipes.

8. The liquid distributor branch pipe structure according to claim 1, wherein an outer diameter of a stainless steel pipe in at least one branch pipe component is set to be greater than or equal to 2 mm and less than or equal to 4.5 mm, with a wall thickness greater than or equal to 0.18 mm and less than or equal to 0.52 mm.

9. The liquid distributor branch pipe structure according to claim 1, wherein a branch pipe component, away from the liquid distributor body, of the two branch pipe components further comprises a copper connection section welded to the other end of the stainless steel pipe opposite to the copper connecting pipe and configured to connect an external pipeline.

10. A liquid distributor branch pipe structure, comprising two branch pipe components, wherein each branch pipe component comprises a stainless steel pipe and a copper connecting pipe welded to an end of the stainless steel pipe, and a stainless steel pipe on one of the branch pipe components is welded to a liquid distributor body;
copper connecting pipes on the two branch pipe components are sleeved, and a brazed layer formed by non-furnace brazing is formed in a sleeving gap, a stainless steel pipe in one branch pipe component extends out of a corresponding copper connecting pipe to form a stainless steel extension section, the stainless steel extension section extends into the other branch pipe component, a blocking region is formed at an assembly gap or a spacing chamber between an outer peripheral wall of the stainless steel extension section and an inner peripheral wall of the other branch pipe component, to block extension of the brazed layer towards an end surface of the stainless steel extension section.

11. The liquid distributor branch pipe structure according to claim 10, wherein the stainless steel extension section extends into a stainless steel pipe in the other branch pipe component, an end surface of a copper connecting pipe corresponding to the stainless steel extension section abuts against an end surface of a stainless steel pipe in the other branch pipe component, and the blocking region is an assembly gap between the outer peripheral wall of the stainless steel extension section and an inner peripheral wall of the stainless steel pipe in the other branch pipe component.

12. The liquid distributor branch pipe structure according to claim 10, wherein the stainless steel extension section extends into a stainless steel pipe of the other branch pipe component, an end surface of a copper connecting pipe corresponding to the stainless steel extension section does not abut against an end surface of a stainless steel pipe in the other branch pipe component, and the blocking region comprises a spacing chamber between the outer peripheral wall of the stainless steel extension section and an inner peripheral wall of a copper connecting pipe in the other branch pipe component and an assembly gap between the outer peripheral wall of the stainless steel extension section and the inner peripheral wall of the stainless steel pipe in the other branch pipe component.

13. The liquid distributor branch pipe structure according to claim 10, wherein the stainless steel extension section extends into a copper connecting pipe in the other branch pipe component, and the blocking region is a spacing chamber between the outer peripheral wall of the stainless steel extension section and an inner peripheral wall of the copper connecting pipe in the other branch pipe component.

14. The liquid distributor branch pipe structure according to claim 10, wherein each copper connecting pipe comprises a first assembly section and a second assembly section, and second assembly sections of the two copper connecting pipes are sleeved; and a shortest axial spacing from an end of a second assembly section of a sleeving copper connecting pipe to an exposed region of each stainless steel pipe is greater than or equal to Φ, wherein Φ is an outer diameter of an inserted copper connecting pipe.

15. The liquid distributor branch pipe structure according to claim 14, wherein a copper connecting pipe in each branch pipe component is sleeved on an end of a corresponding stainless steel pipe.

16. The liquid distributor branch pipe structure according to claim 10, wherein an outer diameter of a stainless steel pipe in at least one branch pipe component is set to be greater than or equal to 2 mm and less than or equal to 4.5 mm, with a wall thickness greater than or equal to 0.18 mm and less than or equal to 0.52 mm.

17. The liquid distributor branch pipe structure according to claim 10, wherein a branch pipe component, away from the liquid distributor body, of the two branch pipe components further comprises a copper connection section welded to the other end of the stainless steel pipe opposite to the copper connecting pipe and configured to connect an external pipeline.

18. A liquid distributor, comprising the liquid distributor branch pipe structure as claimed in claim 1.

19. A liquid distributor, comprising the liquid distributor branch pipe structure as claimed in claim 9.
